(19) United States
(12) Patent Application Publication
(10) Pub. No.: US 2007/0030416 A1
(43) Pub. Date: Feb. 8, 2007

(54) Liquid crystal display

(76) Inventors: Yong-woo Lee, Suwon-si (KR); Yoon-soo Kwon, Anyang-si (KR); Hyun-chul Bae, Suwon-si (KR); Jae-sang Lee, Cheonan-si (KR)

Correspondence Address: CANTOR COLBURN, LLP, 55 GRIFFIN ROAD SOUTH, BLOOMFIELD, CT, 06002, US

(21) Appl. No.: 11/499,427

(22) Filed: Aug. 4, 2006

(30) Foreign Application Priority Data
Aug. 4, 2005 (KR) 2005-0071170

(51) Int. Cl. G02F 1/1335

(52) U.S. Cl. 349/67

(57) ABSTRACT

A liquid crystal display including an LCD panel, a surface light source providing light to a rear of the LCD panel, a container accommodating the surface light source and a reflecting sheet. The container includes a bottom surface in which the surface light source is seated and a reflecting surface extended from the bottom surface and inclined upward toward the LCD panel. The reflecting sheet covers the reflecting surface.

This application claims priority to Korean Patent Application No. 2005-0071170, filed on Aug. 4, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a backlight unit including a surface light source and a liquid crystal display having the same.

2. Description of the Related Art

In general, a liquid crystal display (LCD) is a device that displays images by adjusting light transmittance through liquid crystal cells aligned in a matrix form according to an image signal. The LCD includes an LCD panel having a thin film transistor (TFT) substrate, a color filter substrate and liquid crystals interposed between both substrates.

The LCD panel does not emit light by itself, and thus the LCD further includes a backlight unit in a rear of the TFT substrate to provide light.

The backlight unit includes an optical film disposed at a back of the LCD panel and a light source irradiating the light to the LCD panel. The light source may be a cold cathode fluorescent lamp (CCFL), an external electrode fluorescent lamp (EEFL), a flat fluorescent lamp (FFL) of a surface light source and etc.

The surface light source has advantages of high brightness and brightness uniformity, consuming low electricity and a long life as compared with other light sources. Further, the surface light source may not include a light guiding plate and a reflecting plate, thereby efficiently reducing a manufacturing cost. Thus, the surface light source has been employed in wide scope.

Unlike the CCFL or the EEFL, however, the surface light source emits light only forward, and thus shadow area is generated in a circumference where the surface light source is adjacent to an accommodating container. Conventionally, a mold frame including a slant reflecting surface is disposed in each circumference where the surface light source is adjacent to the accommodating container, thereby decreasing the shadow area and fixing the surface light source.

However, the reflecting surface of the mold frame is not good in reflectance, but the surface light source may be broken due to flexure or burr generated in the mold frame by an external impact.

### BRIEF SUMMARY OF THE INVENTION

Exemplary embodiments provide a backlight unit and an LCD having the same which is improved in light efficiency and impact resistance.

Exemplary embodiments provide a liquid crystal display including an LCD panel, a surface light source providing light to a rear of the LCD panel, a container accommodating the surface light source and a reflecting sheet. The container includes a bottom surface in which the surface light source is seated and a reflecting surface extended from the bottom surface and inclined upward toward the LCD panel. The reflecting sheet covers the reflecting surface.

In exemplary embodiments, the reflecting surface is disposed at opposing sides of the container.

In exemplary embodiments, an inclined angle of the reflecting surface to the bottom surface is in a range of about 95 degrees and about 130 degrees.

In exemplary embodiments, the surface light source includes a plurality of light emitting parts extended in one direction and parallel to each other and space partitioning parts formed between the light-emitting parts.

In exemplary embodiments, opposite ends of a section of the light emitting parts taken along an extending direction of the light emitting parts is rounded In exemplary embodiments, the reflecting surface is parallel to a long side of the light emitting parts.

In exemplary embodiments, the reflecting sheet is extended from the reflecting surface to at least a portion of the bottom surface.

In exemplary embodiments, the liquid crystal display further includes a mold frame disposed at opposite ends of the light emitting parts. The mold frame includes a slant surface and a supporting surface. The slant surface slants to a surface of the surface light source and is formed with a plurality of inserting holes where at least a portion of the light emitting parts is inserted. The supporting surface extends from the slant surface to be parallel with the LCD panel.

In exemplary embodiments, the liquid crystal display further includes an optical film disposed between the LCD panel and the surface light source, wherein the supporting surface supports an edge of the optical film.

In exemplary embodiments, the liquid crystal display further includes a reflecting layer formed on the slant surface.

In exemplary embodiments, an angle of the slant surface to the surface of the surface light source is in a range of about 5 degrees and about 40 degrees.

In exemplary embodiments, the container further includes a connecting surface connecting the bottom surface and the reflecting surface, wherein the connecting surface protrudingly extends toward the LCD panel to form an accommodating space where the surface light source is accommodated.

Exemplary embodiments provide a backlight unit including a surface light source, a container accommodating the surface light source and a reflecting sheet. The container includes a bottom surface in which the surface light source is seated and a reflecting surface extended from the bottom surface and inclined upward toward the LCD panel. The reflecting sheet covers the reflecting surface.

In exemplary embodiments, the reflecting surface includes a supporting surface extended from the inclined part, the supporting surface being parallel with the bottom surface and supporting surface supporting an optical film.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is an exploded perspective view of an exemplary embodiment of an LCD according to the present invention;

FIGS. 2A and 2B are sectional views of the LCD taken along line II-II of FIG. 1;

FIGS. 3A and 3B are sectional views of the LCD taken along line III-III of FIG. 1; and

FIG. 4 is a graph to illustrate an exemplary embodiment of improvement of a shadow area according to the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

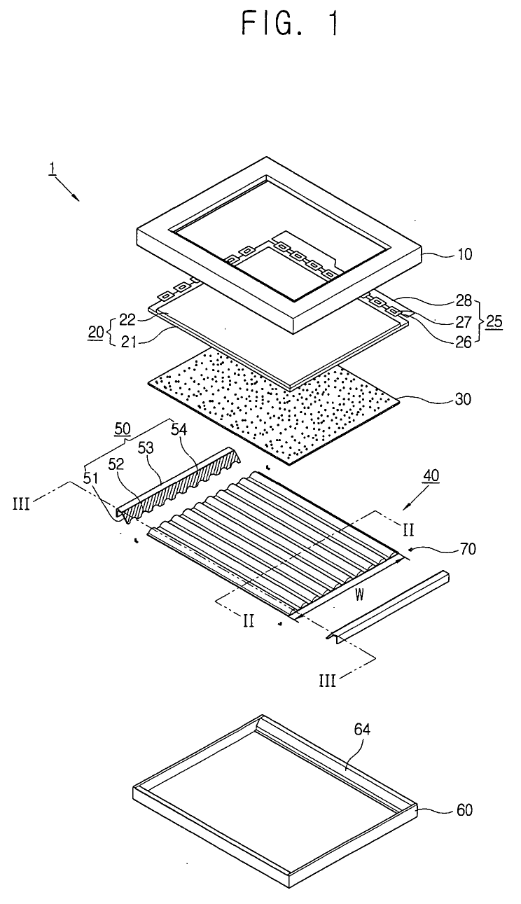

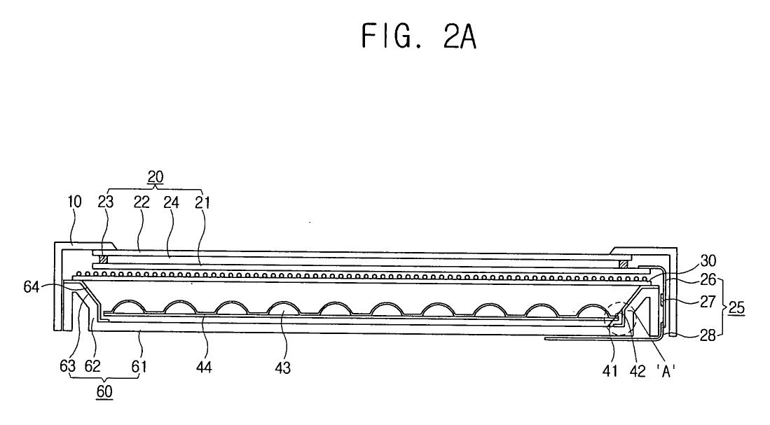

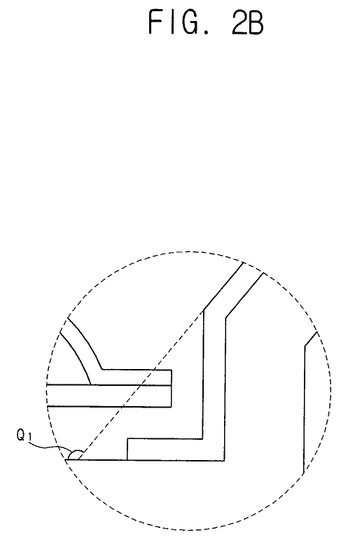

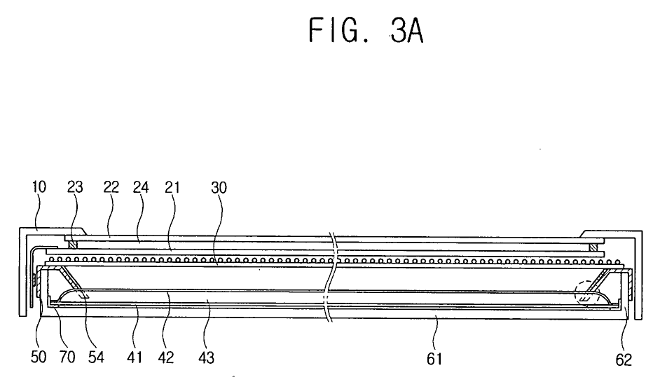

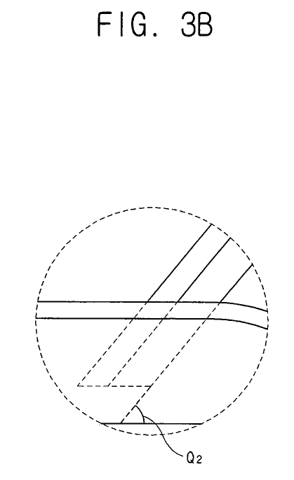

Hereinafter, an exemplary embodiment of an LCD according to the present invention will be described with reference to drawings. FIG. 1 is an exploded perspective view of an exemplary embodiment of an LCD according to an exemplary embodiment of the present invention; FIGS. 2A and 2B are sectional views of the LCD taken along line II-II of FIG. 1; and FIGS. 3A and 3B are sectional views of the LCD taken along line III-III of FIG. 1.

An LCD 1 includes an LCD panel 20, an optical film 30 disposed at a rear of the LCD panel 20 and a surface light source 40 providing light to the LCD panel 20. The LCD panel 20, the optical film 30 and the surface light source 40 are accommodated between a cover 10 and a container 60.

The LCD panel 20 includes a TFT substrate 21 where TFTs are formed, a color filter substrate 22 facing the TFT substrate 21, a sealant 23 adhering both substrates 21 and 22 to each other and forming a cell gap therebetween and a liquid crystal layer 24 disposed between both substrate 21 and 22 and the sealant 23. The LCD panel 20 controls arrangement of liquid crystal molecules within the liquid crystal layer 24, thereby forming images thereon. The LCD panel 20 is provided with light from the surface light source 40 disposed at its rear, since it does not emit light by itself.

A driving part 25 is provided to a side of the TFT substrate 21 to apply a driving signal. The driving part 25 includes a flexible printed circuit (FPC) 26, a driving chip 27 seated on the FPC 26 and a printed circuit board (PCB) 28 connected to a side of the FPC 26. The driving part 25 shown in FIG. 1 is formed in a chip on film (COF) type. Alternative exemplary embodiments may use any other suitable type, such as tape carrier package (TCP), chip on glass (COG) or the like, as the driving part. In exemplary embodiments, the driving part 25 may be formed on the TFT substrate 21 while lines are assembled.

A backlight unit including the optical film 30 and the surface light source 40 is disposed at the rear of the LCD panel 20.

The optical film 30 disposed at the rear of the LCD panel 20 includes a base film and a bead layer coated on the base film. The optical film 30 diffuses the light from the surface light source 40 to provide it to the LCD panel 20. Referring to FIG. 2A, the surface light source 40 includes a space partitioning part 44 where the light is not emitted since there is no light-emitting gas, and thus a dark line may be formed on a screen without the optical film 30.

In alternative exemplary embodiments, the optical film 30 may further include a prism film, a reflecting-polarizing film and/or a protecting film.

The surface light source 40 shown in FIG. 1 includes a plurality of light emitting parts 43 and space partitioning parts 44. The light emitting parts 43 are extended substantially lengthwise in one direction and parallel to each other and provide the light to the rear of the LCD panel 20. The opposite ends of the light emitting parts 43 is rounded. The space partitioning parts 44 are disposed between the light emitting parts 43, such that the light emitting parts 43 and the space portioning parts 44 are arranged alternately in a transverse direction of the LCD panel 20.

As in the illustrated embodiment of FIGS. 2A and 2B, a cross-section of the light emitting parts 43, taken along line II-II has a substantially semicircle shape protruded in a vertical direction from a base of the surface light source 40 toward the LCD panel 20.

The surface light source 40 includes a lower light source member 41 and an upper light source member 42 which are arranged and sealed to each other to form the light emitting parts 43. The lower and upper light source members 41 and 42 may include glass.

A fluorescent substance may be applied on at least one of the lower glass 41 and the upper glass 42. A light-emitting gas, such as including mercury/neon or the like, is disposed within the light emitting parts 43. In exemplary embodiments, the upper glass 42 may be a formed glass having a substantial “wave” shape over all.

The upper glass 42 includes the light emitting parts 43 and the space partitioning parts 44 disposed between the light emitting parts 43. The space partitioning parts 44 of the upper glass 42 contact with the lower glass 41 to support the light emitting parts 43. There is no light emitting gas in the space partitioning parts 44, such that the light does not generate or transmit via the space partitioning parts 44.

In alternative exemplary embodiments, the surface light source 40 may include the upper glass 42 of an unformed glass, such as a plate type and the same as the lower glass 41. In this case, a spacer (not shown) may be used for maintaining an interval or space between the lower glass 41 and the upper glass 42. An area where the spacer is disposed corresponds to the space partitioning parts 44 and the dark line may be formed therein.

A mold frame 50 is disposed on a side of the container 60. A mold frame 50 may be disposed at opposite sides of the container 60 in a substantially transverse direction of the light emitting parts 43, as illustrated in the exemplary embodiment of FIG. 1. The mold frame 50 may be disposed at an end or at opposite ends of the light emitting parts 43.

The mold frame 50 may include a slant surface 51 slanting towards a surface of the surface light source 40 or a surface of the lower glass 41. A supporting surface 53 is extended from an upper edge of the slant surface 51 substantially parallel with the LCD panel 20. Inserting holes 52 (or cutouts) are formed in the slant surface 51, such that ends of the light emitting parts 43 are inserted thereinto. Portions between the inserting holes 52 correspond in position and arrangement to the space partitioning parts 44 of the surface light source 40. The supporting surface 53 supports an edge of the optical film 30.

Referring to FIG. 3B, an angle Q2 is formed between slant surface 51 and the lower glass 41. In exemplary embodiments, the angle Q2 is in a range of about 5 degrees and about 40 degrees.

In exemplary embodiments, a light profile of the surface light source 40 in a substantially perpendicular direction is in a range of about 0 degree and about 50 degrees right and left or up and down relative to the light source 40. An angle Q2 of the slant surface 51 is in a range of about 5 degrees and about 40 degrees to obtain optimal reflectance. Advantageously, a shadow area generated where the surface light source 40 is adjacent to the container 60 may be decreased. In order to increase the reflectance of the slant surface 51, a reflective substance may be added to the slant surface 51, such as when the mold frame 50 is manufactured.

A reflecting layer 54 may be formed on at least a portion of the slant surface 51 so as to further increase light efficiency. In exemplary embodiments, the reflecting layer 54 includes the same material as a reflecting sheet 64 (See FIG. 2A) to increase brightness uniformity.

The mold frame 50 of the illustrated exemplary embodiments has a similar structure to that of a side mold employed to the CCFL. A mold frame 50 is disposed at each of opposite ends of the light emitting parts 43, thereby reducing a manufacturing cost and simplifying a manufacturing process. Moreover, a size of the mold frame 50 may be decreased, thereby reducing flexure or burr while manufacturing the mold frame 50. Advantageously, the mold frame 50 decreasingly interferes with the surface light source 40 and damage to the surface light source 40 by external impact may be reduced or effectively prevented. Impact reliability increases, thereby increasing stability with respect to a structure of the mold frame 50. Further, the mold frame 50 is simplified in its structure, thereby enhancing the efficiency of the assembly process of the LCD 1.

In the illustrated exemplary embodiments, where the LCD 1 is impacted as much as 50G, i.e. fifty times the force of gravity, from six directions of X, −X, Y, −Y, Z and −Z for about 11 seconds, the surface light source 40 is not broken. In an impact reliability test, breakage or shaking is also decreased such that the LCD 1 passes the impact reliability test. The LCD 1 is stable against the external impact as the surface light source 40 decreasingly interferes with the mold frame 50.

The container 60 accommodates the surface light source 40. The container 60 includes a bottom surface 61 where the surface light source 40 is seated and a reflecting surface 63 extended from the bottom surface 61 at a predetermined slant toward the LCD panel 20. The container 60 further includes a connecting surface member 62 connecting the bottom surface 61 and the reflecting surface 63. The connecting surface 62 extends from the bottom surface 61 in a substantially perpendicular (vertical) direction toward the LCD panel 20 to form an accommodating space where the surface light source 40 is accommodated.

Referring again to FIG. 2A, the reflecting surface 63 is provided at opposing lateral sides of the container 60 and substantially parallel with a longitudinal (extended) direction of the light emitting parts 43. In alternative exemplary embodiments, the reflecting surface 63 may be provided on one or more than two lateral sides of the container 60 in a different way from the exemplary embodiment.

An angle Q1 is formed between reflecting surface 63 and the bottom surface 61. In exemplary the angle Q1 is in a range of about 95 degrees and about 130 degrees. The reflecting surface 63 inclines at 5 degrees to 40 degrees to the perpendicular direction.

In exemplary embodiment, a light profile of the surface light source 40 in a substantially perpendicular direction is in a range of about 0 degree and about 50 degrees right and left or up and down relative to the bottom surface 61. The light does not exit outside the range, thereby forming a shadow area. The shadow area is generated in an adjacent area of the surface light source 40 and the container 60. The shadow area is more generated in an area where the container 60 is provided parallel with an extended direction of the light emitting parts 43 adjacent to the space partitioning parts 44 of the non-emitting area of the surface light source 40.

To decrease the shadow area, exiting light should be reflected to where the shadow area is. As the light exits in the range of about 0 degree and about 50 degrees right and left or up and down perpendicularly to the surface light source 40, and the angle Q1 between the bottom surface 61 and the reflecting surface 63 should be in a range of 95 degrees and 135 degrees to effectively reflect the light to the shadow area and to obtain the best reflectance.

In order to maximize the reflectance and minimize the shadow area, a reflecting sheet 64 may be adhered to the reflecting surface 63. The reflecting sheet 64 may be extended to at least a portion of the bottom surface 61 from the reflecting surface 63. Advantageously, the shadow area generated where the surface light source 40 is adjacent to the container 60 may be decreased.

Referring again to FIGS. 1 and 3A, a lamp supporting member 70 is disposed at a corner of the container 60. The lamp supporting member 70 may be disposed at one or at every inside bottom corner of the container. The lamp supporting member 70 includes a soft material absorbing impact, such as silicon rubber, so that the surface light source 40 may stably be seated in the bottom surface 61. The lamp supporting member 70 may also include an insulating material, thereby decreasing an electric interference between the container 60 and the surface light source 40.

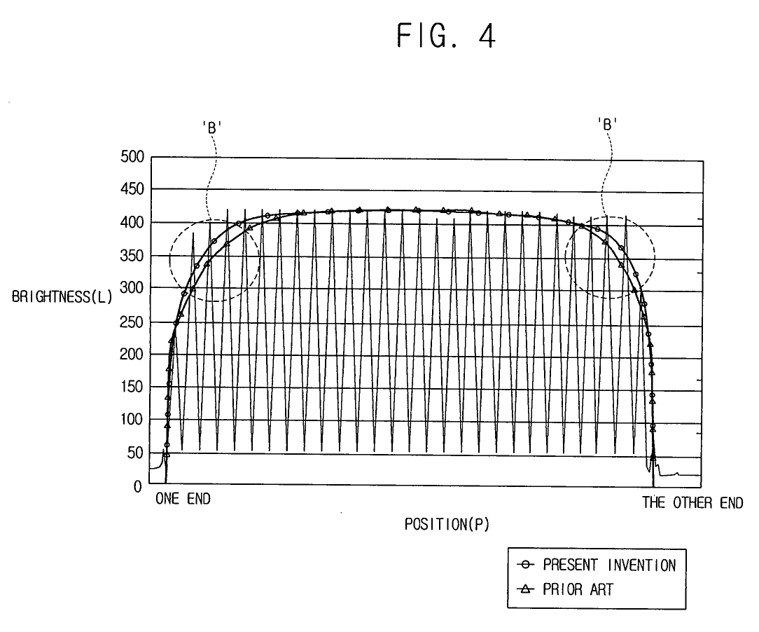

FIG. 4 is a graph to illustrate an exemplary embodiment of improvement a shadow area of the LCD 1 according to the present invention. An X axis shows a position P of the surface light source 40 according to an arrangement direction “W” of the light emitting parts 43 from one end to the other end, and a Y axis shows brightness L. A line plotted up and down in a zig-zag pattern, shows brightness distribution according to distance of the light exiting from the surface light source 40. A line along triangular points shows brightness distribution according to the position of the surface light source 40 detected by the LCD panel 20 in the case that the mold frame 50 having the slant surface 51 is disposed along the edge of the container 60 conventionally. A line along circular points shows brightness distribution according to the position of the surface light source 40 detected by the LCD panel 20 in the case that the reflecting sheet 64 is adhered to the reflecting surface 63.

As shown in FIG. 4, the light exiting from the surface light source 40 has high brightness where the light emitting parts 43 are disposed and low brightness where the space partitioning parts 44 are disposed since the light exits only in the light emitting parts 43.

As shown in ‘B’, the light exiting from where the container 60 is adjacent to the surface light source 40 has low brightness. This exiting light has low brightness because the shadow area is made toward the container 60 parallel with the extended direction of the light emitting parts 43 which is adjacent to the space partitioning parts 44 of the non-emitting area of the surface light source 40. Further, this exiting light has low brightness because the light is not diffused until the light is provided to the LCD panel 20, in the case that the surface light source 40 does not include a reflecting sheet in the bottom surface of the container 60.

The shadow area is made where the container 60 is adjacent to the surface light source 40 due to low brightness detected by the LCD panel 20 in a conventional LCD.

However, the line along circular points indicates where the reflecting surface 63 slanting at 95 degrees to 135 degrees is formed on the lateral side of the container 60 and the reflecting sheet 64 is adhered thereto Brightness is improved approximately 9 percent to 12 percent in a location where the container 60 is adjacent to the surface light source 40. The reflectance is improved due to the reflecting sheet 64 and the light exiting from the light emitting parts 43 is reflected toward the shadow area is to effectively decrease the shadow area. Advantageously, light efficiency and brightness uniformity of the backlight unit are improved.

The illustrated exemplary embodiments provide a backlight unit and an LCD having the backlight unit that is improved in light efficiency and impact resistance.

Although exemplary embodiments have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display comprising:
an LCD panel;
a surface light source providing light to a rear of the LCD panel;
a container accommodating the surface light source and comprising a bottom surface on which the surface light source is seated and a reflecting surface extended from the bottom surface and inclined toward the LCD panel; and
a reflecting sheet covering the reflecting surface.

2. The liquid crystal display according to claim 1, wherein the reflecting surface is disposed at opposing sides of the container.

3. The liquid crystal display according to claim 2, wherein an inclined angle of the reflecting surface to the bottom surface is in a range of about 95 degrees and about 130 degrees.

4. The liquid crystal display according to claim 2, wherein the surface light source comprises:
a plurality of light emitting parts extended in one direction and parallel to each other; and
space partitioning parts formed between the light-emitting parts.

5. The liquid crystal display according to claim 4, wherein opposite ends of a cross-section of the light emitting part taken along an extending direction of the light emitting parts is rounded.

6. The liquid crystal display according to claim 4, wherein the reflecting surface is parallel to a long side of the light emitting parts.

7. The liquid crystal display according to claim 1, wherein the reflecting sheet is extended from the reflecting surface to at least a portion of the bottom surface.

8. The liquid crystal display according to claim 4, further comprising a mold frame disposed at opposite ends of the light emitting parts,
the mold frame comprising:
a slant surface slanting to a surface of the surface light source and formed with a plurality of inserting holes where at least a portion of the light emitting parts is inserted; and
a supporting surface extended from the slant surface to be parallel with the LCD panel.

9. The liquid crystal display according to claim 8, further comprising an optical film disposed between the LCD panel and the surface light source,
wherein the supporting surface supports an edge of the optical film.

10. The liquid crystal display according to claim 8, further comprising a reflecting layer formed on the slant surface.

11. The liquid crystal display according to claim 8, wherein an angle of the slant surface to the surface of the surface light source is in a range of 5 degrees and 40 degrees.

12. The liquid crystal display according to claim 1, wherein the container further comprises a connecting surface connecting the bottom surface and the reflecting surface,
wherein the connecting surface protrudingly extends toward the LCD panel to form an accommodating space where the surface light source is accommodated.

13. A backlight unit comprising:
a surface light source;
a container accommodating the surface light source and comprising a bottom surface in which the surface light source is seated and a reflecting surface extended from the bottom surface and inclined toward the surface light source; and
a reflecting sheet covering the reflecting surface.

14. The backlight unit according to claim 13, wherein the reflecting surface is disposed at opposing sides of the container.

15. The backlight unit according to claim 14, wherein an inclined angle of the reflecting surface to the bottom surface is in a range of about 95 degrees and about 130 degrees.

16. The backlight unit according to claim 14, wherein the surface light source comprises:
a plurality of light emitting parts extended in one direction and parallel to each other; and
space partitioning parts formed between the light-emitting parts.

17. The backlight unit according to claim 13, wherein the reflecting sheet is extended from the reflecting surface to at least a portion of the bottom surface.

18. The backlight unit according to claim 13, wherein the reflecting surface comprises a supporting surface extended from the inclined part, the supporting surface being parallel with the bottom surface and supporting surface supporting an optical film.

19. A method of forming a liquid crystal display, the method comprising:
disposing a surface light source in a container and at a rear of an LCD panel, the container comprising a bottom surface on which the surface light source is disposed and a reflecting surface extended from the bottom surface and inclined toward the LCD panel; and
covering the reflecting surface with a reflecting sheet;
wherein the reflecting surface is disposed at opposing sides of the container; and
wherein the reflecting sheet extends from the reflection surface to a portion of the bottom surface at an edge of the surface light source.
